(19) United States
(12) Patent Application Publication
(10) Pub. No.: US 2024/0127669 A1
(43) Pub. Date: Apr. 18, 2024

(54) COMPUTER-IMPLEMENTED SYSTEMS AND METHODS FOR DYNAMICALLY DISTRIBUTING AWARDS FOR ELECTRONIC GAMING AND DYNAMIC DATA TABLES THEREFOR

(71) Applicant: POARCH BAND OF CREEK INDIANS, d/b/a PCI GAMING AUTHORITY, Atmore, AL (US)

(72) Inventors: Peter A. CONNELLY, Seattle, WA (US); James F. Dorris, JR., Spanish Fort, AL (US)

(73) Assignee: POARCH BAND OF CREEK INDIANS, d/b/a PCI GAMING AUTHORITY, Atmore, AL (US)

(21) Appl. No.: 18/487,308

(22) Filed: Oct. 16, 2023

Related U.S. Application Data
(60) Provisional application No. 63/379,890, filed on Oct. 17, 2022.

(51) Int. Cl. G07F 17/32

(52) U.S. Cl. CPC G07F 17/3244; G07F 17/3239; G07F 17/3276

(57) ABSTRACT

Computer-implemented systems and methods are provided for dynamically controlling the distribution of awards for an electronic game. In one implementation, the method comprises one or more operations performed by at least one processor, including receiving game player data for the electronic game, and determining a distribution table input based on the game player data. The operations of the method further include generating a distribution table based on the determined distribution table input, the distribution table including a plurality of probabilities associated with the plurality of predetermined awards, generating an award table based on the generated distribution table, the award table including a plurality of award identifiers, and distributing awards to the players based on the award table.

### TECHNICAL FIELD

The present disclosure generally relates to the field of computing systems and data processing systems and methods. More specifically, and without limitation, this disclosure relates to computer-implemented systems and methods for dynamically distributing awards, and data tables for implementing and managing electronic gaming systems, methods, and machines. The present disclosure also relates to systems and methods for controlling the allocation of electronic awards, distributions, and/or payouts using dynamic distribution tables.

### BACKGROUND

Electronic gaming is a worldwide industry that continues to grow in size and prominence. It offers both online and on-premises experiences for users from a wide range of demographics. Due to advancements in computer and networking technologies, electronic gaming is offered in many convenient forms to players, including but not limited to, online and networked games, social games, mobile games, electronic gaming machines, casino games, primary and secondary games, tournaments, arena games, and so on. The dynamic nature and real-time environment of electronic gaming also contributes to the engagement level and success of many games.

To implement an electronic game, there are often numerous variables that need to be addressed and managed, such as the number of players, the number and type of awards, the waged or offered amount, the odds of winning or advancing, and/or the selection or application of promotions, enhancements, bonuses, penalties, disqualifications, and/or payouts. These can vary dynamically from game to game. A challenge for electronic gaming software and management systems is to effectively address these variables in an efficient manner in view of available processing resources and data, while ensuring smooth and stable game play for players.

Electronic games can provide an interactive environment for players and often include a combination of video, graphics, and/or sound. Players in a game session can play against one another or in groups and compete for awards or prizes, depending on the rules and/or odds of winning the game. Electronic game management systems are often implemented with hardware and software, such as one or more servers embedded with management software. They can monitor and control games automatically without the need for a human operator. However, there exists technical challenges with such systems, in addition to managing the above-mentioned variables. For example, some game management systems are inadequately designed to manage high volumes of games and accompanying variables, particularly in environments where there is a high instance of games played simultaneously. Others are programmed with little or no flexibility and/or ability to process game data inefficiently. Consequently, they cannot adapt or effectively manage electronic games that are dependent on real-time game instances and play action variables.

Accordingly, there is a need for improved electronic game management systems and methods that can effectively address and apply variables that impact a game, while conserving system resources and ensuring smooth game play for players. There is also a need for improved systems and methods that can provide automated game management features for high volumes of games and dynamic game instances. Still further, there is a need for improved electronic game management systems and methods that can adapt and effectively manage games in real-time and adjust to play action variables and dynamically distribute awards based on such variables.

### SUMMARY

The present disclosure generally relates to the field of computing systems and data processing systems and methods. More specifically, and without limitation, this disclosure relates to computer-implemented systems and methods for dynamically distributing awards for electronic gaming, and data tables for implementing and managing electronic gaming systems, methods, and machines. The embodiments disclosed herein include systems and methods for controlling the allocation of electronic gaming awards, prizes, and/or payouts based on such dynamic distribution tables.

Embodiments of the present disclosure include systems and methods for generating dynamic distribution tables to control the allocation of electronic awards, prizes, and/or payouts for electronic games. Dynamic distribution tables according to the present disclosure may be designed to provide flexibility and enable real-time adjustments and/or modifications. For example, the dynamic distribution tables may take into account real-time conditions of the game instance and context, such as the number of active players. the odds of winning or advancing, and/or the number available awards or prizes. Moreover, embodiments of the present disclosure may be implemented to apply and manage variables that affect game instances and awards over predetermined period(s) of times. Extant systems that involve static tables and award distribution systems fail to provide this level of flexibility and/or real-time adjustment capabilities. Extant solutions are also inefficient in their implementation or do not provide sufficient scaling capabilities, particularly for situations where a large number of games need to be managed and/or there is an array of different gaming variables that exist.

Consistent with the present disclosure, computer-implemented systems are provided that include one or more computing apparatuses configured to perform particular operations or actions by virtue of having software, firmware, hardware, or a combination of them installed thereon that in operation causes or cause the computing apparatus to perform the operations or actions. For example, one or more computer programs may be configured to perform operations or actions by virtue of including instructions that, when executed by a data processing apparatus (such as one or more processors), cause the apparatus to perform such operations or actions.

In accordance with the disclosed embodiments, computer-implemented game management systems and methods are provided. By way of example, a system is provided that includes a controller configured to validate one or more of a plurality of players to participate in an electronic game on respective ones of a plurality of gaming machines and enable game play in the electronic game by the validated players on the respective ones of the plurality of gaming machines. The system may also include a data analyzer configured to: receive game player data from the plurality of gaming machines; determine, from the game player data, at least one of a place, score, or position of each of the validated plurality of players; retrieve, from the memory, data associated with a distribution of a plurality of awards a memory, wherein the data may include a dynamic distribution table identifying a distribution of a plurality of awards; and award distribution of each of the plurality of awards in accordance with the dynamic distribution table. As disclosed herein, the data analyzer may also be configured to perform other operations. For example, the data analyzer may be configured to collect data associated with the awards distributions including whether each award distribution was successful or unsuccessful and store, in the memory, data associated with the awards distribution.

In accordance with additional embodiments of the present disclosure, computer-implemented systems and methods are provided for dynamically distributing awards. By way of example, a method is provided that includes a plurality of operations performed with at least one processor. The method may include retrieving, from a memory, predetermined awards, wherein each predetermined award is associated with an award identifier. The method may also include receiving, from the memory, game player data. The method may include determining a distribution table input from the retrieved game player data, wherein the distribution table input is at least one of a total wager or a number of active players participating in the game from among a plurality of players associated with a plurality of gaming machines. The method may include generating a distribution table based on the distribution table input. As part of the method, the generating of the distribution table may include: comparing the distribution table input to distribution tables stored in the memory; selecting, based on the comparison, one of the stored distribution tables in the memory; and retrieving, from the memory, stored data associated with the selected distribution table, wherein the stored data includes a set of probabilities to win each predetermined award. The method may also include generating an award table based on the generated distribution table. As part of the method, the generating of the award table may include generating an award from the predetermined awards for the player based on the set of probabilities and matching the award identifier with a player identifier. The method may also include storing, in the memory, data associated with the generated award table.

Still further embodiments of the present disclosure relate to systems and methods for dynamically controlling the distribution of awards for an electronic game. By way of example, a method includes a plurality of operations performed by at least one processor. The method may include: retrieving, from a memory, stored data associated with an award table including a plurality of award identifiers, wherein the award table is generated based on distribution table input related to an electronic game; determining player identifiers corresponding to the award identifiers, wherein there is at least one player identifier that is determined for at least one of the plurality of award identifiers; distributing awards for the electronic game, identified by the plurality of award identifiers, to players corresponding to the determined player identifiers; and storing data, in the memory, to record the distribution of awards to the players.

Yet additional embodiments of the present disclosure related to systems and methods for dynamically generating award probabilities. By way of example, the system may include at least one processor configured to: retrieve, from a memory, predetermined awards, wherein each predetermined award may be associated with an award value; retrieve, from the memory, game player data; determine, using a dynamic distribution table generator, a first set of probabilities a first player from a plurality of players wins each predetermined award, wherein the first set of probabilities are based on the game player data; determine, using the dynamic distribution table generator, a second set of probabilities a second player from the plurality of players wins each predetermined award, wherein the second set of probabilities are based on the game player data; store the determined first set of probabilities in a distribution table, wherein each probability of the determined first set of probabilities corresponds to the predetermined awards; and updating, in the distribution table, the determined first set of probabilities with the determined second set of probabilities. In some embodiments, the updating of the first set of probabilities with the determined second set of probabilities is performed when or in response to an award being distributed to the first player awarded an award.

The foregoing and following examples are provided for the convenience of the reader to provide a basic understanding of such embodiments and does not wholly define the breadth of the present disclosure. Therefore, this summary is not an extensive overview of all contemplated embodiments and is intended to neither identify key or critical elements of all embodiments nor to delineate the scope of any or all aspects. Instead, its purpose is to present some concepts of one or more embodiments in a simplified form as a prelude to the more detailed description that is presented herein.

### BRIEF DESCRIPTION OF THE DRAWINGS

FIG. 1 illustrates an exemplary embodiment of a dynamic game management system, consistent with embodiments of the present disclosure.

FIG. 2 illustrates an exemplary computing apparatus for implementing systems and methods for dynamic game management of electronic games, consistent with embodiments of the present disclosure.

FIG. 3 illustrates an exemplary embodiment for a dynamic gaming system, consistent with embodiments of the present disclosure.

FIG. 4 another exemplary embodiment for a dynamic gaming system, consistent with embodiments of the present disclosure.

FIG. 5 illustrates an exemplary method for dynamically controlling the distribution of awards, consistent with embodiments of the present disclosure.

FIG. 6 illustrates an exemplary method for dynamically allocating awards, consistent with embodiments of the present disclosure.

FIG. 7 illustrates an exemplary method for dynamically generating award probabilities, consistent with embodiments of the present disclosure.

FIG. 8 illustrates exemplary award and distribution tables, consistent with embodiments of the present disclosure.

FIG. 9 illustrates exemplary award and distribution tables, consistent with embodiments of the present disclosure.

FIG. 10 illustrates exemplary award and distribution tables, consistent with embodiments of the present disclosure.

It will be understood that the foregoing general description and the following detailed description are exemplary and explanatory only and are not restrictive of the disclosed embodiments.

### DETAILED DESCRIPTION

Example embodiments are described herein with reference to the accompanying drawings. The figures are not necessarily drawn to scale. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used herein and in the appended claims, the singular forms “a,” “an,” and “the” include plural references unless the context clearly dictates otherwise.

Throughout this disclosure there are references to “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

Embodiments described herein include non-transitory computer readable medium containing instructions that when executed by at least one processor, cause the at least one processor to perform a method or set of operations. Non-transitory computer readable mediums may be any medium capable of storing data in any memory in a way that may be read by any computing device with a processor to carry out methods or any other instructions stored in the memory. The non-transitory computer readable medium may be implemented to include any combination of software, firmware, and hardware. Software may preferably be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”), a memory, and input/output interfaces. The computer platform may also include an operating system and microinstruction code. The various processes and functions described in this disclosure may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium may be any computer readable medium except for a transitory propagating signal.

The memory may include any mechanism for storing electronic data or instructions, including Random Access Memory (RAM), a Read-Only Memory (ROM), a hard disk, an optical disk, a magnetic medium, a flash memory, other permanent, fixed, volatile or non-volatile memory. The memory may include one or more separate storage devices collocated or disbursed, capable of storing data structures, instructions, or any other data. The memory may further include a memory portion containing instructions for the processor to execute. The memory may also be used as a working memory device for the processors or as a temporary storage.

Some embodiments may involve at least one processor. “At least one processor” may constitute any physical device or group of devices having electric circuitry that performs a logic operation on an input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory.

In some embodiments, the at least one processor may include more than one processor. Each processor may have a similar construction, or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically, or by other means that permit them to interact.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

In the following description, various working examples are provided for illustrative purposes. However, is to be understood the present disclosure may be practiced without one or more of these details. Reference will now be made in detail to non-limiting examples of this disclosure, examples of which are illustrated in the accompanying drawings. The examples are described below by referring to the drawings, wherein like reference numerals refer to like elements. When similar reference numerals are shown, corresponding description(s) are not repeated, and the interested reader is referred to the previously discussed figure(s) for a description of the like element(s).

Various embodiments are described herein with reference to a system, method, device, or computer readable medium. It is intended that the disclosure of one is a disclosure of all. For example, it is to be understood that disclosure of a computer readable medium described herein also constitutes a disclosure of methods implemented by the computer readable medium, and systems and devices for implementing those methods, via for example, at least one processor. It is to be understood that this form of disclosure is for ease of discussion only, and one or more aspects of one embodiment herein may be combined with one or more aspects of other embodiments herein, within the intended scope of this disclosure.

Consistent with the present disclosure, some implementations may involve a network. A network may constitute any combination or type of physical and/or wireless computer networking arrangement used to exchange data. For example, a network may be the Internet, a private data network, a virtual private network using a public network, a Wi-Fi network, a mesh network, a local area network (LAN), a wide area network (WAN), and/or other suitable connections and combinations that may enable information exchange among various components of the system. In some implementations, a network may include one or more physical links used to exchange data, such as Ethernet, coaxial cables, twisted pair cables, fiber optics, or any other suitable physical medium for exchanging data. A network may also include a public, wired network and/or a wireless cellular network. A network may be a secured network or unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near field communications (NFC), or other suitable communication methods that provide a medium for exchanging data and/or information between separate entities.

In some implementations, machine learning algorithms may be trained using training data. Some non-limiting examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, natural language processing algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by a process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters. The machine learning algorithms may be further retrained based on any output.

By way of example, machine learning algorithms may be used to implement one or more operations of the present disclosure, such as: validating one or more of a plurality of players to participate in game play; enabling game play; analyzing game player data; distributing awards; determining distribution table input; generating a distribution table; generating an award table; determining player identifiers; aggregating data; and determining a set of probabilities. For each of these operations, data may be collected and stored. Advantageously, machine learning algorithms may be used for analyzing, matching, and/or comparing collected and/or stored data associated the above operations to help the system manage play action variables and become more efficient and accurate.

Electronic games may be implemented with electronic gaming machines and/or computer-implemented apparatus or systems. Points (e.g., loyalty or reward points) or a form of payment (e.g., a wager or bet) may be applied to play a game. Additionally, or alternatively, a game may not require points or a payment to play. As used herein, the term “game” refers to all forms of games, including online games, physical games, and electronic games. A “game session” refers to an instance of a game with one or more participating players. A “player” refers to a user or human player. A player also includes a simulated player (e.g., a programmed and/or artificial intelligence (AI)-enabled player created and managed by a game server). In some embodiments, a simulated player's skill level may be adjustable to match and/or provide competitive game play other human player(s) in each game. There may be one or more simulated players in each game. Online games may comprise any video game that is accessible partially or primarily via a network such as the Internet. An online game may be played by a single user and/or multiple users. An online game may be accessed via user's device (e.g., a mobile phone, tablet, wearable device, and/or any other computing device). An online game may also be a game conducted at a physical location with an online component. Games at a physical location such as a casino may include physical games (like card games or roulette), as well as electronic games that require the physical presence of the user to play the game. Electronic games may be implemented at a casino or other location using electronic gaming machines, as further described herein.

“Points” refer to or are associated with a quantity or level of achievement, loyalty or other value associated with a user in a system or across multiple systems. Points may be earned or achieved through activities of a user (e.g., playing an online game, staying at a hotel, purchasing food or beverages, purchasing goods or services, etc.). Points may be redeemed or exchanged for discounts, rewards, coupons, gift cards, or other items. In some implementations, points of a user may be redeemed or applied to activate an electronic game, as further disclosed herein. In some embodiments, points may be purchased, distributed, awarded, or earned. For example, points may be purchased and applied to a player's account and/or points may be earned by a player after successfully completing a game or other activity (e.g., purchasing food or a hotel room). Point information associated with a user (e.g., the total number of current points of a user and their point history, including exchanges or redemptions) may be recorded in a database or other memory in a system. In some implementations, point information of a user may be associated with their profile or user account. Further, in some aspects, point information may be accessed when a player is identified via a mobile phone application, a website login, and/or any other process through which their identity is validated. Additionally, or alternatively, point information from memory may be accessed when activity of that user or player is confirmed or reported in the system.

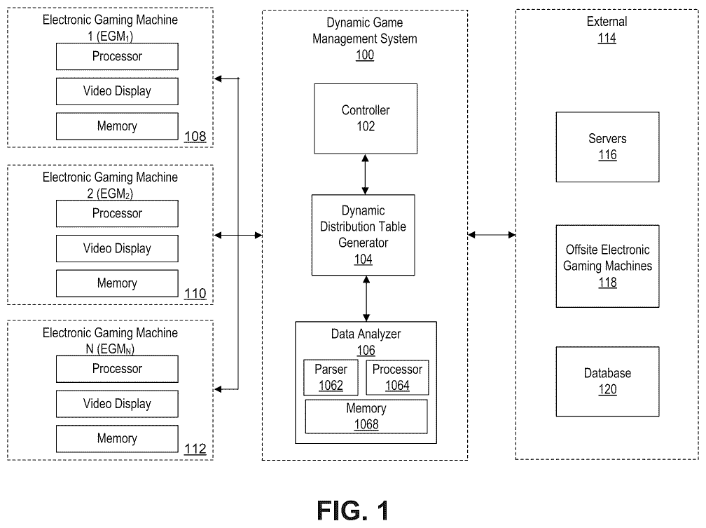

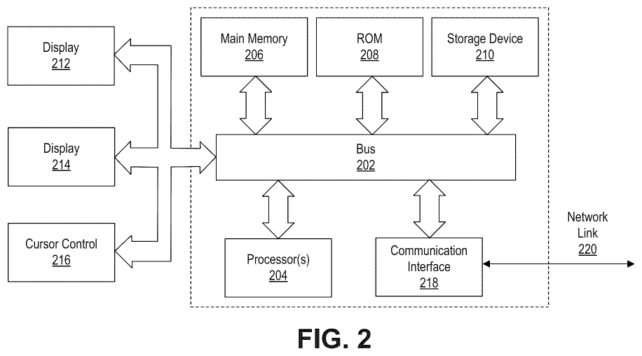

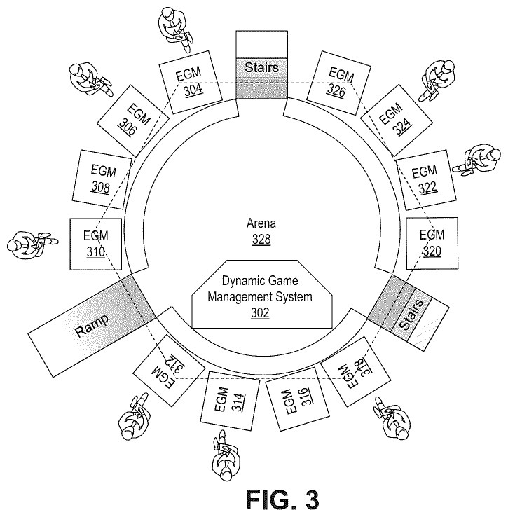

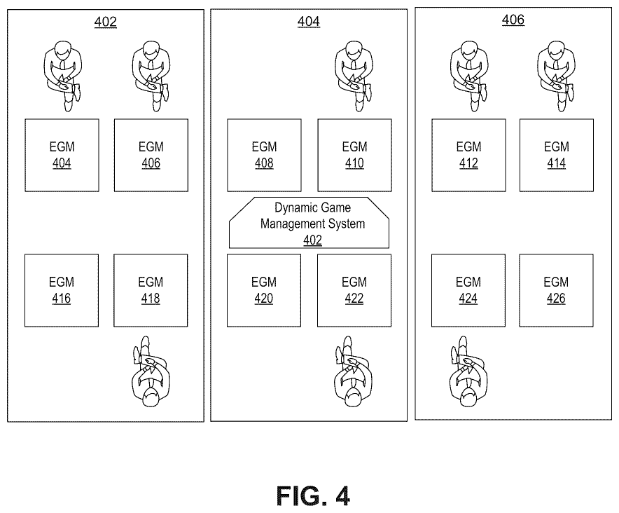

In accordance with embodiments of the present disclosure, computer-implemented gaming systems and methods are provided. The computer-implemented gaming system may include a plurality of electronic gaming machines (see, e.g., EGMs 108-112 of FIG. 1) that enable a plurality of players to play one or more games. The computer-implemented gaming system may be configured to communicate with and send and receive information with the electronic gaming machines (EGMS) for the purpose of controlling and managing the games. In some embodiments, a dynamic game management system is provided as part of the gaming system (see, e.g., system 100 in FIG. 1). As further described herein with reference to the exemplary embodiments of FIGS. 3-4, electronic gaming machines may be physically located in one or more casinos or other regulated environments or physical locations. Electronic gaming machines may be computer-implemented equipment with a combination of hardware, software, and/or firmware components (see, e.g., FIGS. 1-2). Electronic gaming machines may also be provided in various forms (i.e., size, shape, enabled game(s), and other specifications). By way of example, forms of electronic gaming machine machines include console, upright station/monitor, tabletop, reel or slot machine, handheld, and tablet. The components of each electronic gaming machines may include, for instance, one or more of a monitor or display, a display monitor, a game controller or board (including a processor, a memory, and code), a random number generator, a credit input or payment component, an interface processor/board, and/or peripherals, including a video display and one or more buttons, keys, lights, etc. Examples of electronic gaming machines include, but are not limited to, electronic Class III slot machine games, electronic bingo machines, electronic racing machines, video poker machines, electronic table game machines, electronically augmented (e.g., virtual-reality or augmented-reality) table games, electronic sweepstakes machines, centrally determined and server-based game machines, and other electronically-aided gaming machines.

The computer-implemented gaming system may be configured to receive, over one or more networks, data feeds from a plurality of the electronic gaming machines. Each data feed from an electronic gaming machine may comprise data messages through which elements such as player profile data and game player data are provided. The data feed may be sent before, during and/or after a game finishes on the electronic gaming machine and may be used by the computer-implemented gaming system or stored on server(s) or database(s) for subsequent consumption by other applications. The data feed may be implemented using one or more game accounting and/or player tracking systems. Examples of game accounting and/or player tracking systems include Scientific Games' ACSC and CMP Casino Management Systems and SDS Slot Management System, IGT's Advantage CMS player tracking system, Konami Synkros management system, Aristocrat's Oasis 360 system. With such game accounting and/or player tracking systems, the computer-implemented dynamic gaming system may be configured to receive data feeds, over one or more networks, from the electronic gaming machines. As disclosed herein, each of the received data feeds, including player profile information and game player data, may be used by a dynamic game management system (see, e.g., system 100 of FIG. 1) for managing and controlling electronic games, including the validation/status of players and the distribution or allocation of awards.

The computer-implemented gaming system may also be connected via network(s) for communication with one or more external devices (see, e.g., external devices 114 in FIG. 1). For example, the dynamic game management system (100) may be connected to the web (i.e., the Internet) for the purpose of communicating data or displaying information to or from one or more websites on the electronic gaming machines. The dynamic game management system may also receive data from one or more servers (e.g., servers 116, such as game servers or website servers) for creating and managing a game. Further, the dynamic game management system may be configured to send information about the game to a website for display, such as scores or a livestream of the game feed for a tournament or other form of multiplayer game type, such as team against team game play. In some embodiments, the dynamic game management system may be configured to send and receive data associated with game(s) and/or player(s) to and from one or more databases (see, e.g., database 120 in FIG. 1). Such databases may store player profile information, predetermined awards, award and distribution tables, game player data, and/or game results, for example.

According to embodiments of the present disclosure, the computer-implemented gaming system may be connected, via network(s), to one or more offsite electronic gaming machines (see, e.g., offsite EGM 118 in FIG. 1). For example, dynamic game management system (100) may be configured to send and receive data from one or more offsite electronic gaming machines (EGMs) participating in the game(s). Offsite electronic gaming machines (118) may include electronic gaming machines that are in different areas of a single casino or may include electronic gaming machines located in multiple different casinos. Additionally, or alternatively, offsite electronic gaming machines may include electronic gaming machines that are not located in a casino, such as in another physical location and/or may correspond to one or more mobile or online gaming machines, for example.

The electronic gaming machines may include a number of components, such as a processor, a video display, and a memory (see, e.g., EGMs 108-112 in FIG. 1). In some embodiments, each electronic gaming machine includes a game controller or board with at least one processor and a memory. The memory may store programmable instructions (i.e., code) that is executable by the processor. By way of example, the game controller may configure options and rules for games and monitor and control network connections to game server(s) or a game management system. A control panel may be implemented with the game controller to allow an administrator to configure options and rules. The configurable options may include, for example, a time period before the game starts for accepting players, a time length for an opening ceremony of the game, a time length of a game session, a time length for a closing or prize ceremony of the game, a score multiplier for multiplying a score of a winning player, and/or other options. The rules may include a scoring scheme of the game (e.g., a single-round or multi-round scoring scheme), the number of allowed players for the game, whether players of a game need to use game tokens to join or initiate the game, whether special effects (e.g., freezing, shielding, or interfering with other players) are allowed in the game, whether powerups are allowed in the game, whether access to the game is restricted for some players, whether the players are allowed to request awards, whether simulated players (e.g., programmed and/or artificial intelligence (AI)-enabled players created and managed by a game server) can participate in the game, and other rules. Rules can also be set for determining an outcome of the game. For example, a rule can set the multiplier or scoring for players of the game based on whether the game is in a bonus round and/or based on the levels of the players.

The plurality of electronic gaming machines may be used for playing tournaments or a primary game and a secondary game, or a combination thereof. A data analyzer (see, e.g., data analyzer 106 in FIG. 1) may receive and process game player data and other information from the electronic gaming machines to manage and control games. The received game player data may include primary game data and/or secondary game data of one or more players, for example. In some embodiments, data analyzer may receive data from electronic gaming machines equipped with different data tracking and/or collection systems using one or more data formats. By way of example, the data tracking systems may include a system with a data telemetry capability. In some embodiments, the data analyzer may utilize a base or common protocol to merge, combine, re-format, and/or harmonize data received from different data tracking systems or having different data formats for data analysis.

As further disclosed herein, the data analyzer may include a number of components implemented with hardware, software and/or firmware, such as a parser, a processor, and a memory (see, e.g., parser 1062, processor 1064, and memory 1068 in FIG. 1). Parser 1062 may parse received data and processor 1064 may analyze and process the parsed data. In some embodiments, parser 1062 may receive and parse multiple types of received data and put the data into a format consistent with a base or common protocol. The received data may include identifier(s) for identifying an electronic gaming machine and/or a player. For example, parser 1062 may receive and parse an identifier (e.g., a serial number or a unique alphanumeric string) of an electronic game machine or a player. In some embodiments, the identifier may be associated with a token card or player that is provided when logging into the electronic gaming machine or gaming system. In addition, parser 1062 may receive and parse player status or event-type data. For example, event data may include data representing a log-in event, a log-out event, or a game-complete event. The log-in event (such as a “card-in” event) may represent that a player logs into an electronic gaming machine (e.g., by inserting an ID card into the electronic game machine or manually entering an ID). The log-out event (such as a “card-out” event) may represent that a player logs out of an electronic gaming machine (e.g., by pulling out an ID card from the electronic game machine or manually exiting a game and/or machine). The game-complete event may represent that a game has been completed. The completed game may be a primary game or a secondary game or another game. The game-complete event may be represented by or associated with data indicating the amount of the wage or bet and the amount or outcome of the game. In some embodiments, the outcome of the game includes data identifying the win amount or results for the completed game. Data parsed by parser 1062 may be analyzed and processed by processor 1064. For example, processor 1064 may process identification data to validate a player. One or more database(s) may be used by processor to look-up a player profile. Processor 1064 may also process parsed data from the received feeds to determine the progression, status, placement, scoring, and/or position of players, and/or outcome of a game. In some embodiments, a player's progression, position, or scoring in a secondary game may be dependent on the scoring of outcome of their gameplay in a primary game. It may also be dependent on secondary gameplay and outcomes. By way of further example, the player's win amount in a primary game may be multiplied by a predetermined score multiplier to determine the player's progression, position, or scoring in the secondary game. In some secondary games, players of the secondary game may need to complete numerous rounds in one or more primary games before a final score or winner in a secondary game is determined. Examples of secondary games in which players progress or advance based on numerous rounds of gameplay in a primary game include track or race-style games.

The controller may be configured to validate one or more of the plurality of players to participate in a game on respective ones of the plurality of electronic gaming machines. Validating a player may include one or more operations, such as verifying the player's identification, confirming the player's registration and/or player's account in a database, confirming the player's payment or balance for participating in the game, confirming the player's status or eligibility, and/or other operations. For validated players, the controller may be configured to enable game play on the respective ones of the plurality of electronic gaming machines.

The controller may further be configured to determine whether a change occurs with respect to at least one of the plurality of electronic gaming machines or associated plurality of players. When a change is determined to have occurred (e.g., from active to inactive), the controller may be further configured to re-validate one or more of the plurality of players to participate in a game on respective ones of the plurality of electronic gaming machines. When a change is determined to have occurred, the controller may be further configured to re-enable game play for one or more of the validated players on respective ones of the plurality of electronic gaming machines. When a change is determined to have occurred, the data analyzer may be further configured to receive changed game player data from one or more of the plurality of electronic gaming machines. The data analyzer may be further configured to a change at least one of the place, score, or position of at least one of the plurality of players. In some embodiments, when a change is determined to have occurred, the data analyzer may be further configured to store, in a memory, changed game player data from one or more of the plurality of electronic gaming machines and/or data associated with determinations of the changed at least one of the place, score, or position of one or more of the plurality of players.

The data analyzer (106) may be configured to receive game player data from the plurality of gaming machines and determine at least one of a place, score, or position of the validated plurality of players. The game player data may be received directly from the electronic gaming machines (e.g., as part of data feeds) and/or it may be received, parsed and stored in memory and then retrieved and provided for processing. The data analyzer may also be configured to store, in the memory, game player data from the plurality of gaming machines and data associated with determinations of the at least one of the place, score, or position of the validated plurality of players. The data analyzer may be configured to retrieve, from the memory, data associated with a distribution of a plurality of awards. The data analyzer may also be configured to award distribution of each of the plurality of awards. The data analyzer may also be configured to collect data associated with the awards distributions including whether each award distribution was successful or unsuccessful. The data analyzer may also be configured store, in memory or a database, data associated with the awards distribution. Additionally, or alternatively, the data analyzer may be configured to send data associated with the awards distribution to a server.

FIG. 1 illustrates an exemplary computer-implemented gaming system, consistent with embodiments of the present disclosure. The number and arrangement of components in FIG. 1 are for purposes of illustration and not intended to be limiting to the embodiments of the present disclosure. The system of FIG. 1 may be implemented with any suitable combination of hardware, software, and firmware. One or more networks may also be provided to facilitate communication between the components of the system

As shown in FIG. 1, the computer-implemented gaming system includes a dynamic game management system 100 that comprises a controller 102, a dynamic distribution table generator 104, and a data analyzer 106. Each of the components (102, 104, 106) of system 100 may be implemented with a combination with hardware, software, and/or firmware. Controller 102 may perform a number of operations including the management and control of the flow of data by and between dynamic game management system 100 and the other components of the system of FIG. 1. Controller 102 may also enable the configuration of options and rules for game play and/or awards and store the options and the rules in a memory for future access and use. Controller 102 may also be configured to monitor and control network connections to EGMs 108-112 and external devices 114 (such as web servers, game servers, offsite EGMs, and databases). By way of example, controller 102 may include a control panel (comprising one or more graphical user interfaces) that is displayed on a screen to allow an administrator or operated to configure options and/or rules for games. The configurable options and/or rules may be used to manage game play and/or awards. Examples of options and/or rules include: a time period before a game starts for accepting joining players; a time length for a game session; requirements for player eligibility or validation; and so on. Further examples of options and/or rules include: a scoring and/or award scheme for a game; the number of allowed players (minimum and/or maximum); whether players need to use game tokens, points, or a wager for joining or initiating the game; whether players are allowed to request prizes; whether simulated players (e.g., artificial intelligence (AI) enabled players created and managed by a game sever) participate in the game; and so on. Rules can also be set for determining an outcome of the game based on game play, event data, and/or other data parsed and processed by data analyzer 106. As described above, controller 102 may also be configured to perform other operations, such as validating players for a game and identifying and handling status changes (e.g., active v. inactive) during a game with respect to an electronic gaming machine and/or associated player.

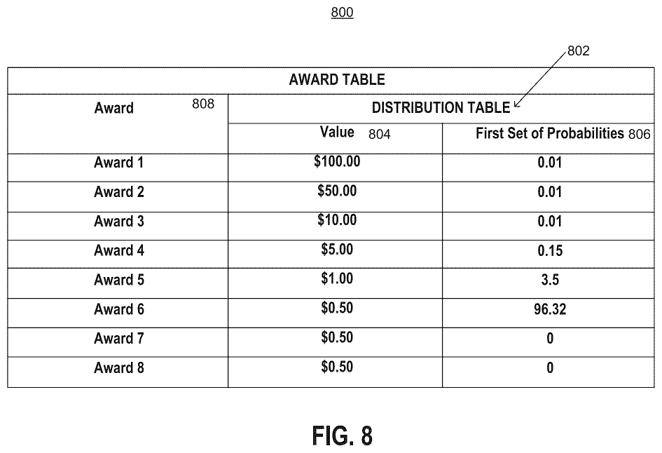

Dynamic distribution table generator 104 may be configured to generate data values and tables for dynamically distributing awards. For example, distribution table generator 104 may be configured to generate one or more award values (see, e.g., 804, 904, 1004 of FIGS. 8-10) for corresponding awards, Award 1, Award 2, Award 3, etc (see, e.g., 808, 908, 1008), as well as sets of probabilities (see, e.g., 806, 906, 1006). Generate may refer to create, produce, bring about, develop, cause, or any other similar way of bringing about award values and/or probabilities. The generated award values and corresponding probabilities may be used to create distribution tables and award tables. As shown in the examples of FIGS. 8-10, award tables (e.g., 800, 900, 1000) may include distribution tables (e.g., 802, 902, 1002). Award tables (e.g., 800, 900, 1000) may also include awards, Award 1, Award 2, Award 3, etc. (e.g., 808, 908, 1008) which may be identified with award identifiers. In some embodiments, controller 102 may be configured to enable an administrator or operator to provide distribution table input and/or other input values and generate award tables (e.g., 800, 900, 1000) and/or distribution tables (e.g., 802, 902, 1002). Data analyzer 106 may also aid in generating award tables and/or distribution tables by parsing and processing game player data and other data with parser 1062 and processor 1064. In addition, memory 1068 may be used to store and/or retrieve award tables and/or distribution tables, as further disclosed herein.

As shown in FIG. 1, dynamic game management system 100 is configured to receive and relay data with a number (N) of electronic gaming machines 108, 110, and 112. Each electronic gaming machine may provide a data feed to dynamic game management system 100 via one or more network(s) (e.g., a LAN, WAN, and/or the Internet). Further, as described above, electronic gaming machines 108, 110, and 112 may enable electronic games to be played by a plurality of players. Among other operations, dynamic game management system 100 may configure and control electronic games running on electronic gaming machines 108, 110, and 112. Game play may include the display of various aspects of a game on the video display of each electronic gaming machine, and the execution and advancement of the game based on the processing of inputs provided by each player through buttons and/or other input peripheral(s) (e.g., touch screen; joystick, mouse, etc) of the electronic display system. As described herein, electronic gaming machines 108, 110, and 112 may be physically located in one or more physical locations, such as casino(s) or other regulated environment(s). Electronic gaming machines 108, 110, and 112 may be computer-implemented equipment with a combination of hardware, software, and/or firmware components. Electronic gaming machines 108, 110, and 112 may also be provided in various forms (i.e., size, shape, enabled game(s), and other specifications). By way of example, electronic gaming machine machines 108, 110, and 112 may include one or more of a console, upright station/monitor, tabletop, reel or slot machine, handheld, and tablet. The components of electronic gaming machines 108, 110, and 112 may include, for instance, one or more of a monitor or display, a display monitor, a game controller or board (including a processor and a memory), a random number generator, a credit input or payment component, an interface processor/board, and peripherals, including a video display and one or more input buttons, keys, lights, etc.

Dynamic game management system 100 may be configured to receive, over one or more network(s), a data feed from each of the electronic gaming machines 108, 110, and 112. The data feed may comprise data messages through which information such as identifiers, player profiles, and game player data are provided. The data feed may be sent before, during and/or after a game finishes on the electronic gaming machines 108, 110, and 112 and may be used by dynamic game management system 100 and/or stored on server(s) or database(s) for subsequent uses by other components. The data feed may be implemented using game accounting and/or player tracking systems supported by the electronic gaming machines 108, 110, and 112. With such game accounting and/or player tracking systems, dynamic game management system 100 may be configured to receive and process data feeds, over a network connection, from electronic gaming machines 108, 110, and 112 made by any of a number of electronic gaming machine manufacturers. As disclosed herein, the received data feed, including identifier(s), player profile information, and game player data, may be used by controller 102, dynamic distribution table generator 104, and data analyzer 106 of system 100 for managing and controlling electronic games, and distributing awards to players.

As disclosed herein, data analyzer 106 may receive data from a plurality of gaming machines (e.g., electronic gaming machines 108, 110, and 112). For example, the plurality of electronic gaming machines may be used to implement one or more games and provide data feeds to data analyzer 106 for managing and controlling such games. In some embodiments, a primary game, a secondary game, or a combination thereof, may be implemented with electronic gaming machines and the data received by data analyzer 106 may include primary game data and/or secondary game data. In some embodiments, data analyzer 106 may receive data from electronic gaming machines equipped with different data tracking and/or collection systems using one or more data formats. By way of example, the data tracking systems may include a system with a data telemetry capability. In some embodiments, data analyzer 106 may utilize a common protocol to merge, combine, re-format, and/or harmonize data received from different data tracking systems or having different data formats for data analysis.

As shown in FIG. 1, data analyzer 106 includes a parser 1062 for parsing data, a processor 1064 for analyzing and processing the parsed data, and a memory 1068 for storing data. In some embodiments, parser 1062 may receive and parse multiple types of received data. The received data may include identifier(s) for identifying an electronic gaming machine and/or a player. For example, parser 1062 may receive and parse an identifier (e.g., a serial number or a unique alphanumeric string) of an electronic game machine or a player. In some embodiments, the identification may be associated with a token card or player that is provided when logging in. In addition, parser 1062 may receive and parse event-type data. As described herein, examples of event data include data representing a log-in event, a log-out event, or a game-complete event.

Computer-implemented dynamic game management system 100 may also connected via one or more network(s) for communication with one or more external devices 114. For example, computer-implemented dynamic gaming system 100 may be connected to one or more servers 116 (e.g., one or more game servers or one or more website servers on the Internet) for the purpose of displaying information from a game server or one or more websites on the electronic gaming machines 108, 110, and 112. Dynamic game management system 100 may also receive data and/or instructions from one or more servers (e.g., one or more game servers or one or more website servers) for creating and managing a game. Further, dynamic game management system 100 may be configured to send information about a game to a website for display, such as scores or a livestream of the game feed for a tournament or other form of multiplayer game type, such as team against team. In some embodiments, dynamic game management system 100 may also be configured to send and receive data associated with game(s) and/or player(s) to and from one or more databases (see, e.g., database 120 in FIG. 1). Such databases may store player profile information, predetermined awards, award and distribution tables, game player data, and/or game results, for example.

As further shown in FIG. 1, dynamic game management system 100 may also be connected, via one or more network(s), to one or more offsite electronic gaming machines 118. For example, computer-implemented dynamic gaming system 100 may be configured to send and receive information from one or more offsite electronic gaming machines 118 participating in the game(s). Offsite electronic gaming machines 118 may include electronic gaming machines that are in different areas of a single casino or may include electronic gaming machines located in multiple different casinos. Additionally, or alternatively, offsite electronic gaming machines 118 may include electronic gaming machines that are not located in a casino, such as in another physical location and/or may correspond to one or more mobile or online gaming machines, for example.

FIG. 2 illustrates an example computing apparatus 200 for implementing dynamic gaming systems and methods consistent with embodiments of the present disclosure. By way of example, computing apparatus 200 may be used to implement components of the disclosed systems herein, such as the electronic gaming machines (EGMs) as well as the controller, dynamic distribution table generator, and data analyzer of the dynamic game management system. It will be appreciated that FIG. 2 is a non-limiting example and that modifications can be made to the number and arrangement of components of apparatus 200. Moreover, other computer-implemented apparatus may be utilized for implementing the systems and methods of the present disclosure.

As shown in FIG. 2, apparatus 200 includes a bus 202 and/or other communication components for communicating information and one or more hardware processor(s) 204 communicatively coupled with bus 202 for receiving and transmitting information. Processor(s) 204 can include, for example, a general-purpose microprocessor or central processing unit. Apparatus 200 also includes a main memory 206, such as a random access memory (RAM) or other dynamic storage devices, coupled to bus 202 for storing information and instructions to be executed by processor 204. Main memory 206 also can be used for storing temporary variables or other intermediate information during the execution of instructions to be executed by processor 204. Such instructions, when stored in non-transitory storage media accessible to processor 204, render computing apparatus 200 into a special-purpose machine that is customized to perform the operations specified in the instructions. computing apparatus 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

In some embodiments, computing apparatus 200 can be coupled via bus 202 to a display device 212, such as a cathode ray tube (CRT), liquid crystal display, or touch screen, for displaying information to a computer user. An input device 214, including alphanumeric and other keys, may also be coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. The input device can have two degrees of freedom in two axes, a first axis (for example, x) and a second axis (for example, y), that allows the device to specify positions in a plane.

Computing apparatus 200 can implement components of the disclosed embodiments herein using customized hard-wired logic, one or more ASICs or FPGAs, firmware, software and/or program logic, which in combination causes or programs computing apparatus 200 to be a special-purpose machine. According to some embodiments, the operations, functionalities, and techniques disclosed herein are performed by computing apparatus 200 in response to processor(s) 204 executing one or more sequences of one or more instructions contained in main memory 206. Such instructions can be read into main memory 206 from another storage medium, such as storage device 210. Execution of the sequences of instructions contained in main memory 206 causes processor 204 to perform process steps consistent with disclosed embodiments. In some embodiments, hard-wired circuitry of firmware can be used in place of or in combination with software instructions.

Various forms of computer-readable media can be involved in carrying one or more sequences of one or more instructions to processor(s) 204 for execution. For example, the instructions can initially be carried on a magnetic disk or solid state drive of a remote computer. The remote computer can load the instructions into its dynamic memory and send the instructions over a network line communication line using a modem, for example. A modem local to computing apparatus 200 can receive the data from the network communication line and can place the data on bus 202. Bus 202 carries the data to main memory 206, from which processor(s) 204 retrieve and execute the instructions. The instructions received by main memory 206 can optionally be stored on storage device 210 either before or after execution by processor(s) 204.

Computing apparatus 200 also includes a communication interface 218 coupled to bus 202. Communication interface 218 provides a two-way data communication coupling to a network link 220 that is connected to a network, such as a local network or public network. For example, communication interface 218 can be an integrated services digital network (ISDN) card, cable modem, satellite modem, or a modem to provide a data communication connection to a corresponding type of telephone line or data network. As another example, communication interface 218 can be a local area network (LAN) card to provide a data communication connection to a compatible LAN. Communication interface 218 can also use wireless links (e.g., WiFi) and communicate to public networks such as the Internet. Communication interface 218 may send and receive electrical, electromagnetic, and/or optical signals that carry digital data streams representing various types of information.

Network link 220 may provide data communication through one or more networks. For example, network link 220 can provide a connection through a local network to other computing devices connected to the local network or to an external or public network, such as the Internet or other Wide Area Network (WAN). These networks use electrical, electromagnetic, and/or optical signals that carry digital data streams. The signals through the various networks and the signals on network link 220 and through communication interface 218, which carry the digital data to and from computing apparatus 200, are examples of forms of transmission media. Computing apparatus 200 can send messages and receive data, including program code, through the network(s), network link 220 and communication interface 218. In the Internet example, a server (not shown) can transmit requested code for an application program through the Internet (or Wide Area Network), the local network, and communication interface 218. The received code can be executed by processor(s) 204 as it is received and/or stored in storage device 210 or other non-volatile storage for later execution.

Referring now to FIG. 3, an exemplary embodiment is provided for a dynamic gaming system, consistent with the present disclosure. In the example of FIG. 3, a dynamic gaming system is shown with a plurality of electronic gaming machines 304, 306, 308, 310, 312, 314, 316, 318, 320, 322, 324, and 326. As disclosed above, electronic gaming machines may be provided to enable players to participate in game(s) (e.g., one or more tournament games or other electronic games). By way of example, electronic gaming machines 304-326 may be arranged on a casino floor around a designated arena 328. In some embodiments, there may be one or more such arenas staged in a casino or across multiple casino locations. For example, the arena 328 may have an elevated stage (not shown in FIG. 3) and one or more ramps and stairs may be provided for access to the arena. In some embodiments, a live attendant or host may be on the arena for announcements during a tournament or playing of game(s). As depicted in FIG. 3, the dynamic game management system 302 (with similar operations and features to system 100 in FIG. 1, described above) may be physically located, in-part or whole, in proximity to the electronic gaming machines 304, 306, 308, 310, 312, 314, 316, 318, 320, 322, 324, and 326, participating in the game. Parts of the dynamic game management system 302 may also be located not in near physical proximity to the electronic gaming machines 304, 306, 308, 310, 312, 314, 316, 318, 320, 322, 324, and 326. As shown in FIG. 3 (see also FIG. 4), one or may gaming machines may be vacant and therefore not include a player participating in a game, such as electronic gaming machines 308, 316, 320 and 326. Furthermore, machines that are not vacant (e.g., electronic gaming machines 312 and 322) may include players that are participating in different games from the rest of the players in the arena. For example, players associated with electronic gaming machines 304, 306, 310, 314, 318, and 324 may be participating in a secondary game related to primary game, while players associated with electronic gaming machines 312 and 322 may be engaged in other games. Actively played games include any combination of different games or different instances of the same game that occur simultaneously and that are supported by the dynamic game management system, consistent with embodiments of the present disclosure.

By way of further example, one or more video displays of the dynamic game management system 302 may be located in near physical proximity to the arena and electronic gaming machines, while other components such as the supporting modules and server components, are in network communication but located elsewhere. As will be appreciated from this disclosure, arena 328 may be configured in different layouts than that illustrated in FIG. 3. Further, online and/or offsite electronic gaming machines may be networked and supported by the same dynamic game management system as supporting the electronic gaming machines of FIG. 3, thereby expanding the pool of participating players for any individual game.

FIG. 4 illustrates another example dynamic gaming system with an arrangement of a plurality of electronic gaming machines. As shown in this example, one or more of electronic gaming machines 404, 406, 408, 410, 412, 414, 416, 418, 420, 422, 424, and 426 are provided to allow players to participate in one or more electronic game(s). By way of example, the electronic gaming machines (EGMs) may be configured in groups of four electronic gaming machines, such as groups 402, 404, and 406 or in any other interval or grouping. In some embodiments, these groupings may allocate seats for players to participate in the same instance of a game. Groups of EGMs may be physically located in the same floor area of a casino or they may be placed in separate areas or locations within the same casino or across multiple casinos. A communication network (not shown in FIG. 4) may support the transfer of data, inputs, and instructions between the electronic gaming machines 404-426 and dynamic game management system 402 (with similar operations and features to system 100 in FIG. 1, described above). In some embodiments, electronic gaming machines may be incrementally added and networked with the dynamic game management system 402, including online and offsite electronic gaming machines. Additionally, there may be display panels and lights above the electronic gaming machines 404-426 to present the status of the game(s). Furthermore, the dynamic game management system 402 may use a portion of the video display screen(s) of the underlying electronic gaming machines for game initiation, management, and status display, which may have touch screen capabilities.

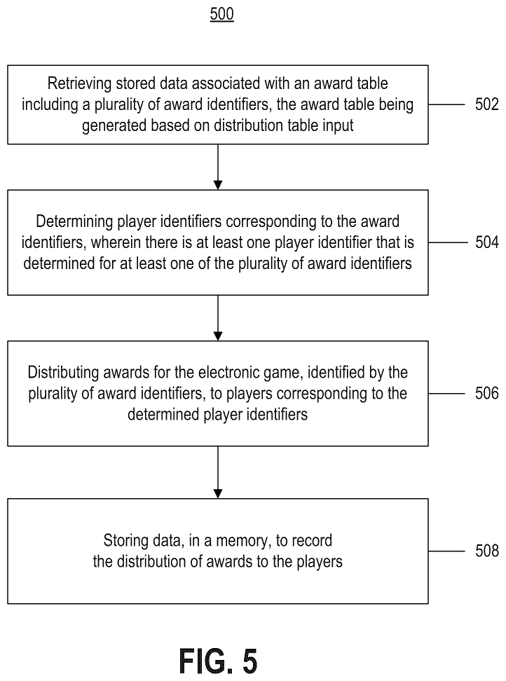

FIG. 5 illustrates an exemplary method 500 for dynamically controlling the distribution of awards. The steps of method 500 may be implemented with at least one processor and modified as desired, including by reordering steps and/or inserting or deleting steps. By way of example, the method of FIG. 5 may be implemented with the system of FIG. 1, including the dynamic game management system 100 and the components thereof.

As shown in FIG. 5, method 500 includes a step 502 of retrieving stored data associated with an award table including a plurality of award identifiers. The award table may be generated for an electronic game based on a distribution table. The distribution table may be generated based on distribution table input and/or other data related to the electronic game or game session. Method 500 also includes a step 504 of determining player identifiers corresponding to the award identifiers. In some embodiments, there may be at least one player identifier that is determined for at least one of the plurality of award identifiers. The players associated with the player identifiers are active players who participated in the electronic game or game session using their respective electronic gaming machines. Players who actively participate in a game can vary from game to game or session to session. Method 500 further includes a step 506 of distributing awards for the electronic game, identified by the plurality of award identifiers, to players corresponding to the determined player identifiers for the game. Method 500 also includes a step 508 of storing data, in the memory, to record the distribution of awards to the players.

Embodiments of the present disclosure include systems and methods dynamically controlling the distribution of awards for an electronic game. Distributing awards may include conferring, granting, rewarding, or other ways giving an award as a payment, compensation, or prize. In some embodiments, awards associated with an electronic game may be award to players based on their performance, score, or placement in the game. The awards may be distributed according to an award table dynamically generated for each electronic game or game session. All distributed awards may be recorded and stored in memory or a database. In a casino or other electronic gaming environment where players register and have unique accounts, awards may be distributed by updating a player's account or awards balance to reflect the distributed award. As will be appreciated, this is a non-limiting example. Depending on the type or form of the award, it may be distributed to and/or redeemed by a player electronically, virtually, in-person, or on-premises, for example.

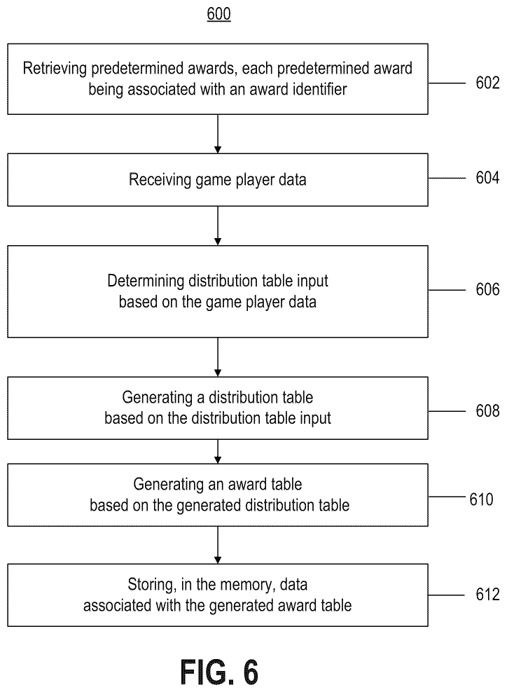

Referring again to FIG. 5, method 500 for dynamically controlling the distribution of awards includes a retrieving step (step 502) to retrieve stored data associated with an award table for an electronic game (see, e.g., award table 800, 900, 1000 of FIGS. 8-10) including a plurality of award identifiers. As disclosed herein, each award table may be generated based on a distribution table. The distribution table may be generated based on distribution table input related to the electronic game. For example, each award table may include a distribution table (see, e.g., 802, 902, 1002). In some embodiments, distribution table input is used to generate a distribution table and then an award table is generated using the distribution table and includes a plurality of award identifiers (see, e.g., 808, 908, 1009). An exemplary method for generating award tables is described with reference to FIG. 6. Controller 102 and data analyzer 106 (and distribution table generator 104) may be used to generate an award table (and the distribution table thereof). For example, controller 102 may collect data and/or retrieve stored data and then provide it to data analyzer 106 (and/or distribution table generator 104) for processing. Data analyzer 106 may aid in generating award tables using parser 1062 and processor 1064. In addition, memory 1068 may be used to store and/or retrieve data (such as a distribution table) associated with an award table for an electronic game. Additionally, or alternatively, data associated with an award table may be stored and retrieved from a database, such as database 120.

As disclosed herein, each award table (e.g., 800, 900, 1000) may include a plurality of award identifiers (e.g., Award 1, Award 2, Award 3, Award 4, etc). Award identifiers (e.g., 808, 908, 1008) in an award table may dynamically vary from game-to-game or from time-to-time. Award identifiers may identify awards for different outcomes, order, scoring, or placement in an electronic game. For example, Award 1 may identify an award for finishing first, Award 2 may identify another award for finishing second, Award 3 may identify an award for finishing third, and so on. In some embodiments, the amount or value of an award may be greatest for a finishing first and then decrease in value for subsequent outcomes, order, scoring, or placement.

The example method 500 of FIG. 5 also includes a determining step (step 504) to determine player identifiers corresponding to the award identifiers in the award tables. In some embodiments, there may be at least one player identifier determined for at least one of the plurality of award identifiers. By receiving and accessing game player data and/or other data, data analyzer 106 may determine player and/or award identifiers. For example, data analyzer 106 may receive game player data and/or other data from electronic gaming machines equipped with data tracking and/or collection systems using one or more data formats to determine player and/or award identifiers. Based on the data, player identifiers may be identified for each award identifier depending on the placement of the players and results of the game. For example, parser 1062 may parse the game player data to identify an electronic gaming machine, player identifier, and/or award identifier and processor 1064 may process the parsed data to determine the placement of validated and/or active payers and the results of each game. For example, a first player may finish first in the game and be assigned a first player identifier. Thereafter, the first player identifier may be determined to correspond to a first award identifier in the award table and be assigned to that award identifier. This process may continue for each of the remaining validated and/or active players in the electronic game (e.g., a second player, a third player, etc) to determine and assign player identifiers, awards, and award identifiers. In some embodiments, players may be filtered out from processing for purposes of award distribution if they are not validated, were disqualified from the game, had an inactive status (e.g., failed to participate in game play), or had an active status but failed to place, finish, or achieve sufficient points to receive an award. In some embodiments, players that participated but had an insufficient placement or finishing may still receive an award (i.e., a participation award).

Consistent with embodiments of the present disclosure, a distribution table may be used to control the distribution of awards and award tables may be based on such distribution tables. Distribution tables may be generated using distribution table input. Distribution table input may address one or more dynamic variables related to a game. For example, distribution table input may include: a number of active players participating in a game or game session; a total wager or game value amount; conditions or promotions applied to a game or game session; a number of verified or active players; a change in the number of verified and/or active players; and/or other dynamic variables associated with a game or game session. By way of example, assume the number of active players in a game session is 5 players. The selected distribution table for that game may be a five-player distribution table. Using the five-player distribution table, an award table may be generated and include corresponding award identifiers. For example, the award table may include Awards 1-8 with corresponding award values of $1 USD, $2 USD, $3 USD, $4 USD, $5 USD, $6 USD, $7 USD, and $8 USD. Further, the five-player distribution table may include the first set of probabilities for each award value: 0.01%, 0.01%, 0.01%, 0.15%, 3.5%, 96.32%, 0%, and 0%, respectively. As a further example, in some embodiments, the award table may include awards associated with different prize tiers, such as a first prize from a first prize tier for a first player, a second prize from a second prize tier for a second player, a third prize from a third prize tier for a third player, and another prize from another prize tier for another player.

Referring again to FIG. 5, method 500 may further include an award distributing step (step 506) to distribute awards for the electronic game, identified by the plurality of award identifiers, to players corresponding to the determined player identifiers, and a recording step (step 508) to store data to record the results of the distribution of awards to the players. Award distributing step 506 and/or recording step 508 may be performed by data analyzer 106. For example, processor 1064 may analyze and process the parsed data from parser 1062 to determine, distribute, and/or record awards, according to distributing step 506 and/or recording step 508.

Disclosed embodiments include storing data, in a memory or database, associated with distributed awards. Other data may be stored and retrieved, such as data associated with different award tables and data reflecting distributed awards for different games or game sessions. In some embodiments, different awards, identified by different award identifiers, may be awarded to different sets of identified players for a plurality of games.

In some embodiments, stored data associated with game player data may be retrieved from a memory or database. The game player data may include data identifying a first-place player, a second-place player, a third-place player, and so on. Game player data may also include data identifying each validated player, active player, inactive player, disqualified player for a game or game session. By way of example, a first-place player may be matched with a first player identifier, a second-place player may be matched with a second player identifier, and a third-place player may be matched with a third player identifier. As a further example, the game player data may include data identifying a first-position player, a second-position player, and a third-position player for a game or game session. In such instances, the first-position player may be matched with a first player identifier, the second-position player may be matched with a second player identifier, and the third-position player may be matched with a third player identifier. As a still further example, the game player data may include data identifying a first-score player, a second-score player, and a third-score player for a game or game session. In such cases, the first-score player may be matched with a first player identifier, the second-score player may be matched with a second player identifier, and the third-score player may be matched with a third player identifier.

Disclosed embodiments include distributing awards, identified by award identifiers, to the identified players from a plurality of players. Consistent with present disclosure, awards may be distributed based on the placement, position, and/or score of players of a game. Players that participated in a game or game session but did not have a sufficient placement, position, or score, may still receive participation awards. Participation awards may include awards given to players for taking part in or playing a game, provided they are not disqualified or deemed inactive, if applicable. Non-limiting examples of participation awards may include credits to be used to play a game, a voucher, and bonus awards.

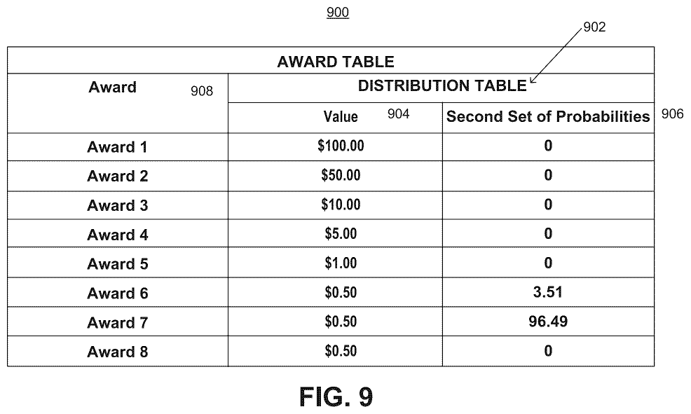

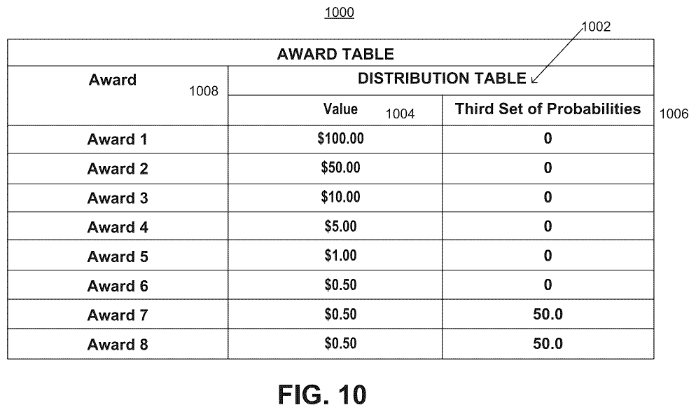

The probability of winning an award may vary from award to award and/or player to player. The probabilities of winning an award may also vary across different award tables and/or distribution tables (see, e.g., FIGS. 8-10) and outcomes. By way of example, if a first-place players wins an award with a value of $5 USD (see Award 4 in FIG. 8), a second set of probabilities for available awards may include: 0%, 0%, 0%, 0%, 0%, 3.51%, 96.49%, and 0%, respectively (see Awards 1-8 and the respective probabilities in FIG. 9). Continuing with this example, if a second-place player wins an award with a value of $0.50 USD, a third set of probabilities for available awards may include: 0%, 0%, 0%, 0%, 0%, 0%, 50%, and 50%, respectively (see Awards 1-8 and the respective probabilities in FIG. 10).

According to still further embodiments of the present disclosure, a computer-implemented method is provided for dynamically distributing awards. Consistent with disclosed embodiments, the method may include operations performed with at least one processor, including retrieving, from a memory, stored data associated with an award table. The award table may include award identifiers corresponding to player identifiers. The method further includes distributing awards, identified by award identifiers, to the identified players from a plurality of players. The method additionally includes storing data, in a memory or database, associated with the distribution of awards.

Embodiments of the present disclosure include systems and methods for dynamically generating data tables for allocating awards. By way of example, FIG. 6 illustrates an exemplary method 600 for dynamically generating award tables for distributing awards in accordance with the method of FIG. 5. The steps of the disclosed method 600 may be implemented with at least one processor and modified as desired, including by reordering steps and/or inserting or deleting steps. By way of example, the method of FIG. 6 may be implemented with the system of FIG. 1, including controller 102, dynamic distribution table generator 104 and/or other components of dynamic game management system 100.

Method 600 includes a step 602 of retrieving, from a memory, predetermined awards, wherein each predetermined award is associated with an award identifier. Data analyzer 106 may perform step 602 of FIG. 6. This step may be performed after or concurrently with one or more electronic games that are played or completed, for example. As part of step 602, data analyzer 106 may retrieve, from a memory or database, predetermined awards, wherein each predetermined award is associated with an award identifier. For example, processor 1064 may perform step 602 in connection with parsing (with parser 1062) and analyzing game player data and other data (such as event data). The predetermined awards may be grouped or categorized by, for example, one or more prize carousels or servers. The grouping or categorization may be based on one or more parameters, such as a type of a game, a length of a game, a difficulty of a game, the time of day the game is played or schedule, and so on. Method 600 also includes a step 604 of receiving game player data. Data analyzer 602 may perform step 604 together with or after 602. For example, data analyzer 602 may receive, parse, and process game player data and other data from electronic gaming machines and/or other sources. Game player data may be received and processed directly from the data feeds of the electronic gaming machines or it may be received after retrieving the game player data from memory.

As shown in FIG. 6, method 600 also includes a step 606 of determining a distribution table input based on the game player data and/or other data. In some embodiments, distribution table input may be determined from game player data and/or other data related to an electronic game or a specific game session. Additionally, or alternatively, distribution table input may be determined based on parameters or data set by an administrator or operator that may be specific to a specific game or game session or applied to games according to their categorization or grouping. Data analyzer 106 and/or controller 102 may perform step 606. For example, data analyzer 106 may receive or retrieve game player data and parser 1062 may parse the received or retrieved game player data for processor 1064 to determine the distribution table input. Additionally, or alternatively, controller 102 may enable an administrator or operator to select, input, and/or set the distribution table input for one or more games. As disclosed herein, distribution table input may address one or more dynamic variables related to an electronic game. For example, distribution table input may include: a number of active players participating in a game or game session among a plurality of players associated with a plurality of gaming machines; a total wager or game value amount; conditions or promotions applied to a game or game session; a number of verified or active players; a change in the number of verified and/or active players; and/or other dynamic variables associated with a game or game session.

As further shown in FIG. 6, method 600 includes a step 608 of generating a distribution table based on the distribution table input. Step 608 may be performed by dynamic distribution table generator 104. Dynamic distribution table generator 104 may work with controller 102 and/or data analyzer 106 in dynamic game management system 100. Distribution table input and other data may be communicated and shared between these components of system 100. In some embodiments, dynamic distribution table generator 104, controller 102, and/or data analyzer 106 may use machine learning algorithms, as described herein, for performing operations related to method 600.

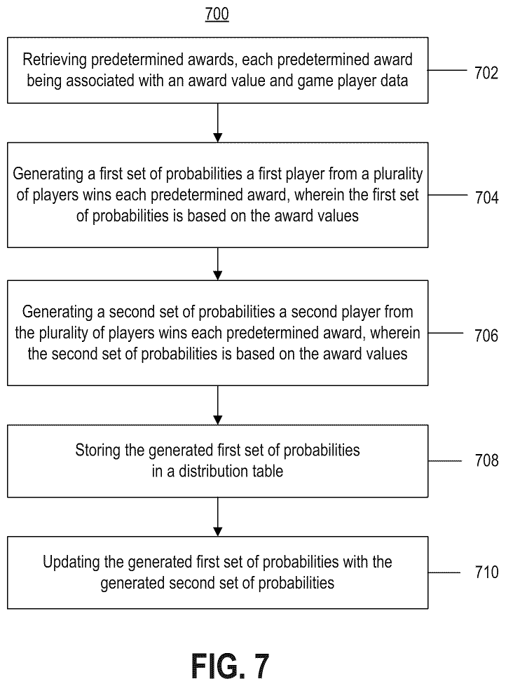

Each distribution table may include award values and corresponding probabilities (see, e.g., FIGS. 8-10). Using the distribution table input for an electronic game (e.g., number of active players and/or total wager), dynamic distribution table generator 104 may populate and generate the distribution table for the electronic game or game session. In some embodiments, the relationship between the distribution table input and award value and probabilities may be prestored, programmed, or learned using machine learning algorithms. By way example, FIG. 7 discloses an exemplary method for calculating probabilities. Award values may be calculated based on a combination of game player date and input values or parameters set by an administrator or operator. For example, award values may be computed based on the number of players participating in a game, a total wager by all payers, a total payout target set by an administrator, and/or a constant value (e.g., 0.05% or 0.06%) set by an administrator. In still further embodiments, distribution tables may be prestored and selected from memory (as part of step 608) based on distribution table input. For example, the distribution table input and/or other data input may be used as a key to select, from memory, a prestored distribution table for generating an award table. In such embodiments, a plurality of distribution tables may be stored and indexed for retrieval based on distribution table input and/or other input data. Machine learning algorithms can analyze and compare tables over time to learn how to accurately generate a table based on input and thereby enable the system to manage gaming variables and control award distributions more accurately for electronic gaming.

After the distribution table is generated, method 600 includes a step 610 of generating an award table based on the generated distribution table. Data analyzer 106 may be configured to generate award tables by using processor 1064. In addition, award tables may be stored and/or retrieved from memory 1068. At least one award table may be generated from the distribution table for an electronic game or game session. The award values and/or probabilities in the award table may be updated, for example, after each award distribution to a player in the game or game session and/or until all awards have been distributed. The total number of awards (and thus award identifiers) assigned and populated in an award table may be coextensive with the number of award values and probabilities in the distribution table used for generating the award table. FIGS. 8-10 illustrates examples of award tables generated from distribution tables.

As will be appreciated, other steps may be performed as part of the example method 600 of FIG. 6. For example, as shown in the figure, method 600 may include a step 612 of storing, in a memory or database, data associated with the generated award table. Data analyzer 106 may perform step 612 of storing, in a memory, data associated with the generated award table. For example, the data associated with the generated award table may be stored for future modifications or updates, to be accessed and/or retrieved to be compared against, and to help improve the machine learning algorithms described herein for embodiments of the award distribution methods and systems.

As disclosed herein, embodiments include retrieving, from a memory, one or more predetermined awards (step 602 of method 600). Each predetermined award may be associated with an award identifier. Retrieving from a memory may refer to accessing, fetching, recalling, and/or any other method of acquiring an object from a memory, such as the memory, databases, or storage devices described herein. An award identifier may refer to data or a characteristic that identifies an award. Non-limiting examples of award identifiers may include an award type, an award amount, an award class, an award ID number, and an award ID name. For example, three classes or tiers of award identifiers may exist: Tier A, Tier B, and Tier C. Awards may be grouped into the tiers based off their identifier.

Disclosed embodiments include receiving, game player data (step 604 of method 600). For example, data analyzer 106 may receive game player data by parsing it from data feeds of the electronic gaming machines or the game player data may be received after retrieving it from memory. Game player data may refer to any set of data or information that relates to or originates from a game. Non-limiting examples of game player data include a number of players, a game identifier, a game type, game progression, player progression, player level, time of game play, a wager amount, a total wager amount, a points amount, a total points amount, a player disqualification, a player time out, a number of active players, a number of validated players, and other game player data. In some examples, the game player data may be retrieved from or sent by game terminals to one or more server(s). The server(s) may include one or more game server(s) or local server(s).

Disclosed embodiments include determining a distribution table input from the retrieved game player data (step 606 of method 600). Distribution table input includes information or data that is used to generate a dynamic distribution table. The distribution table input may be at least one of a total wager for an electronic game or game session or a number of active players participating in the electronic game or game session from among a plurality of players associated with a plurality of electronic gaming machines. Total wager may refer to a whole number of assurances, bets, gambles, money, stakes, pledges, risks, or any other similar complete amount of value on the basis of an outcome. Non-limiting examples of total wager may be $100, $1000, 100 coins, and 1000 coins. In other examples, a total wager includes the total amount of pledged or offered points (e.g., loyalty or award points). The number of active players may be determined based on the number of players engaging or participating in a game. In some embodiments, players are validated before they are permitted to engage or participate in a game. A gaming machine, which is also referred to as an electronic gaming machine, may include any device or apparatus for gaming. As disclosed herein, examples of gaming machines include but are not limited to electronic Class III slot machine games, electronic bingo machines, electronic racing machines, video poker machines, electronic table game machines, electronically augmented (e.g., virtual-reality or augmented-reality) table games, electronic sweepstakes machines, centrally determined and server-based game machines, or any other electronically-aided game machines. Such machines may provide data that associates wagers placed to specific players or is used to generate the wagering outcome in situations where wagers are placed and prizes are awarded. For example, game player data for each gaming machine may be accessed and/or retrieved to determine the number of players, the number of active players, and each wager that each player has placed for a game. The total wager may be determined by adding the wagers by active players together. Any one of the number of players, the number of active players, the individual wagers, the total wager, and other related information or data from the game player data may be used as the distribution table input to generate a distribution table to use. By way of example, the distribution table input for an electronic game or game session may include a number of validated players (e.g., 12), a number of active players (e.g., 6), and/or a total wager (e.g., $100).

Disclosed embodiments include generating a dynamic distribution table based on the distribution table input (step 608 of method 600). Non-limiting examples of generating the distribution table based on the distribution table input may include generating the distribution table completely based on the distribution table input or partially based on the distribution table input. Generating the distribution table may include comparing the distribution table input to stored distribution tables in a memory and selecting a distribution table that corresponds to the distribution table input. For example, the distribution table input may include a number of active players. The distribution table input may be compared to stored distribution tables to identify a matching table. The stored distribution tables may include associated distribution table information, including a stored distribution table input and corresponding stored award table. For example, for a distribution table input of 6 active players there may be match to a stored distribution table for 6 active players and a corresponding award table may also be retrieved. Alternatively, in this example, the award table may not be stored but generated from the selected distribution table. In another example, when the distribution table input does not match the stored distribution table input, a distribution table with an associated stored distribution table input less than the distribution table input may be selected. Advantageously, this provides flexibility so that the distribution table input may be less than a value associated with a stored table. The comparison can be made based on the award values in the distribution table or corresponding award table stored in memory. For example, assume the distribution table input is the number of players and the total wager of all the players for an electronic game. As a non-limiting example, a 12-player total wager of $288 would trigger the $300 value of an award table and not the next one up (e.g., $320).

Generating the distribution table may also include retrieving, from a memory, stored data associated with the generated distribution table. The stored data may include a set of probabilities a player wins each predetermined award. In some embodiments, a second distribution table and/or third distribution table may be generated. The second distribution table and/or third distribution table may include a different set of probabilities a different player wins each predetermined award. In some embodiments, stored data associated with the generated second distribution table and/or third distribution table may be retrieved from the memory,

For example, a five-player distribution table may be selected where the award values include $1 USD, $2 USD, $3 USD, $4 USD, $5 USD, $6 USD, $7 USD, and $8 USD. The five-player distribution table may include the first set of probabilities for each award value: 0.01%, 0.01%, 0.01%, 0.15%, 3.5%, 96.32%, 0%, and 0%, respectively. In this example, if a first-place players wins the award value of $5 USD, the second set of probabilities for each award value may include: 0%, 0%, 0%, 0%, 0%, 3.51%, 96.49%, and 0%, respectively. In this example, if a second-place player wins the award value of $6 USD, the third set of probabilities for each award value may include: 0%, 0%, 0%, 0%, 0%, 0%, 50%, and 50%, respectively.

Disclosed embodiments include generating the award table based on the generated distribution table (step 610 of method 600). Award table may include data defining a table including information relating to awards, award values, and probabilities. In some examples, the award table may include a distribution table. From the generated award table, an award may be determined from the predetermined awards based on the set of probabilities. This may also include matching the award identifier with a player identifier. A player identifier may include a data string, a token, a number, or other information that identifies a player. In some embodiments, the generated award table may be modified, and the modified or updated award table may be stored. For example, modifying the generated award table may include updating award values and/or probabilities. Modifying an award table may also include updating award identifiers and corresponding player identifiers.

Examples of award tables are show in FIGS. 8-10. The information in these tables, including the award values and probabilities, are provided for purposes of illustration and thus non-limiting. As further examples, the award values of the award table may include at least one of “$0,” “$200,” “$500,” “$1,000,” and “$2,000.” Different probabilities may also be used as well as the number of awards.

In some embodiments, one or more of the plurality of players to participate in a game on respective ones of the plurality of gaming machines may be dynamically validated. Validating a player may include authenticating and/or confirming that a player can and/or should gain access to playing a game on a gaming machine. Non-limiting examples of validating players may include periodically validating players, continuously validating players, and validating players based on a condition.

According to another embodiment of the present disclosure, a method for dynamically allocating awards may be provided. Consistent with disclosed embodiments, the method includes retrieving, from a memory, predetermined awards. Each predetermined award may be associated with an award identifier. The method further includes retrieving, from the memory, game player data. The method further includes determining a distribution table input from the retrieved game player data. The distribution table input may be at least one of a total wager or a number of active players from a plurality of players associated with a plurality of gaming machines. The method includes determining a distribution table based on the distribution table input. Determining the distribution table may include comparing the distribution table input to stored distribution tables in the memory. Determining the distribution table may also include selecting one of the stored distribution tables in the memory. The distribution table input may be less than a value of a generated award table. Determining the distribution table may include retrieving, from a memory, stored data associated with the generated distribution table. The stored data may include a set of probabilities a player wins each predetermined award. The method may include determining the award table based on the generated distribution table. Determining the award table may include determining an award from the predetermined awards for the player based on the set of probabilities. Determining the award table may also include matching the award identifier with a player identifier. The method may include storing, in the memory, data associated with the generated award table.

Disclosed embodiments include dynamically generating award probabilities. Dynamically generating award probabilities may refer to developing, creating, originating, initiating, or any other similar way of producing likelihoods, chances, odds, possibilities, or any other extent to which an award is likely to occur by performing logical operations. Non-limiting examples of dynamically generating award probabilities may include generating award probabilities once, periodically generating award probabilities, and generating award probabilities based off a condition being met. An award probability includes a likelihood, chance, odd, possibility, percentage, or any other extent to which an award is likely to occur by performing logical operations.

By way of example, FIG. 7 illustrates an exemplary method 700 for dynamically generating award probabilities. The steps of the disclosed method 700 may be implemented with at least one processor and modified as desired, including by reordering steps and/or inserting or deleting steps. By way of example, the method of FIG. 7 may be implemented with the system of FIG. 1, including the dynamic distribution table generator 104 and/or other components of dynamic game management system 100.

Method 700 includes a step 702 of retrieving, from a memory, predetermined awards 108, wherein each predetermined award is associated with an award value. Data analyzer 106 may perform step 702 of retrieving, from a memory, predetermined awards, wherein each predetermined award is associated with an award identifier. For example, processor 1064 may perform step 702. Processor 1064 may perform step 702 before or after data analyzer 106 analyzes game player data and parses game player data with parser 1062. The predetermined awards may be grouped or categorized by, for example, one or more prize carousels or servers. The grouping or categorization may be based on one or more parameters, such as a type of a game, a length of a game, a difficulty of a game, the time of day the game is played or schedule, and so on.

Method 700 also includes a step 704 of generating a first set of probabilities a first player from a plurality of players wins each predetermined award. The first set of probabilities may be based on game player data that is received from the electronic gaming machines or stored in memory. The first set of probabilities may also be generated based on other data (e.g., variables) related to the electronic game. For example, input data provided by an administrator or operator may be used to generate the first set of probabilities. Step 704 may be performed by data analyzer 106 after receiving and processing game player data, for example. Dynamic distribution table generator 104 may use the generated first set of probabilities to generate distribution table. By way of example, the probabilities may be calculated as a function of one or more of: a number of game sessions; a number of players per game session; an average wager per player; and a constant. For example, if $50,000 is the total amount of money an electronic gaming machine records, $300 of award value may be given. Thus, the function may be based on a number of game sessions, a number of players per game session, and an average wager per player, and a constant, all divided by the number of game sessions times an average number of players per game session. This simplifies to the average wager per player times a constant. From this, probabilities may be generated. In some embodiments, the generated first set of probabilities is based on the award values. For example, a two-player pay table may be set at an average award value of $1.44 and a twelve-player pay table may be set at an average award value of $8.64. This may be generated by observing that the average wager per player is $24 and the system gives out 0.06% of the average wager out as award value.

As further shown in FIG. 7, method 700 also includes a step 706 of generating a second set of probabilities a second player from a plurality of players wins each predetermined award, wherein the second set of probabilities is based on game player data that is received from the electronic gaming machines or stored in memory. Step 706 may be performed by data analyzer 106. Dynamic distribution table generator 104 may then take the generated second set of probabilities to generate distribution table. Step 706 may be performed by dynamic distribution table generator 104. The second set of probabilities may be generated as the first set of probabilities are explained above.

Method 700 further includes a step 708 of storing a generated first set of probabilities in a distribution table or subsequently in an award table. Data analyzer 106 may perform step 708 of storing, in a memory, the generated first set of probabilities in a distribution table. For example, the generated first set of probabilities in a distribution table may be stored for future modifications, to be accessed and/or retrieved to be compared against, and to help improve the machine learning algorithms described herein for related methods and systems. Each probability of the generated first set of probabilities corresponds to predetermined awards.

Method 700 also includes a step 710 of updating the generated first set of probabilities with the generated second set of probabilities. Processor 1064 of data analyzer 106 may work in tandem with dynamic distribution table generator 104 to perform step 710. Step 710 may be performed after an award is allocated to a player. For example, after Player 1 is allocated an award, step 710 may be performed.

Disclosed embodiments include retrieving, from a memory, predetermined awards (step 702 of method 700). Each predetermined award may be associated with an award value. Retrieving from a memory may refer to accessing, fetching, recalling, or any other method of acquiring an object from the memory. Award may refer to a gift, a prize, a credit, a trophy, a certificate, a voucher, or any other similar payment or compensation. Non-limiting examples of an award may include a cash reward, a voucher reward, a point reward, a discount reward, a promotion, or anything that can be awarded. For example, the award may be contingent on player progression, player level, completion and/or progress of a game, and player status. For example, the award could be an increase or decrease in the player progression and/or player level. In addition, the awards may be established or decided in advance. In one example, there may be eight predetermined awards. Awards may be linked to, or associated with, an award value. An award value may refer to an award's worth, benefit, or any other similar estimation of an award. Non-limiting examples of the award value may be monetary value, game value, player value, voucher types, discount amounts, and promotion amounts. For example, in one example, eight awards may be predetermined and assigned to an electronic game. The eight awards may have award values where the first award is a value of $1 USD, the second award a value of $2 USD, and so forth.

Disclosed embodiments include generating, with a dynamic distribution table generator, a first set of probabilities a first player from a plurality of players wins each predetermined award (step 704 of method 700). Disclosed embodiments also include generating, with the dynamic distribution table generator, a second set of probabilities a second player from the plurality of players wins each predetermined award (step 706 of method 700). A second set of probabilities may be the same as, or different from, the first set of probabilities. More than two sets of probabilities may be generated. For example, in some embodiments, the dynamic distribution table generator may generate a third set of probabilities a third player from the plurality of players wins each predetermined award. A dynamic distribution table generator may refer to a component that initiates, creates, spawns, establishes distribution tables. Non-limiting examples of dynamic distribution table generators may include processors or generators that generate distribution tables periodically, continuously, upon a condition being met, incrementally, or during fixed intervals. A distribution table may include data defining a table containing information relating to award values and probabilities. For example, the distribution table may include columns, including one column labeled “Value” for storing award values. The other columns may store probabilities and be labeled “First Set of Probabilities,” “Second Set of Probabilities,” “Third Set of Probabilities,” and so forth. The value column may list the award values and the probability column may list the probability that the corresponding award value may be given to or earned by a player.

The first set of probabilities, the second set of probabilities, and/or the third set of probabilities may be based on the game player data. Non-limiting examples of a set of probabilities being based on game player may include the set of probabilities being wholly based on the game player data and the set of probabilities being partially based on the game player data. For example, the set of probabilities may be weighted based on the game player data.

Disclosed embodiments include storing the generated first set of probabilities in a distribution table or subsequently in an award table (step 708 of method 700). Each probability of the generated first set of probabilities may correspond to the predetermined awards. Storing a set of probabilities in a distribution table or an award table may refer to the process of saving, holding, maintaining, recording, saving, collecting, keeping, and any other similar action of retaining digital data as described herein. In some embodiments, storing the generated first set of probabilities in the distribution table or award table may include storing such data in a memory or database. A set of probabilities may correspond to an award, or its award value. Correspond may refer to correlate, coincide, relate, and any other similar action of matching a probability with an award and/or award value.

For example, for a five-player distribution table, the award values may include $1 USD, $2 USD, $3 USD, $4 USD, $5 USD, $6 USD, $7 USD, and $8 USD. The five-player distribution table may include the first set of probabilities for each award value: 0.01%, 0.01%, 0.01%, 0.15%, 3.5%, 96.32%, 0%, and 0%, respectively. In this example, if a first-place players wins the award value of $5 USD, the second set of probabilities for each award value may include: 0%, 0%, 0%, 0%, 0%, 3.51%, 96.49%, and 0%, respectively. In this example, if a second-place player wins the award value of $6 USD, the third set of probabilities for each award value may include: 0%, 0%, 0%, 0%, 0%, 0%, 50%, and 50%, respectively. Further probabilities may be computed.

Disclosed embodiments include updating the probabilities in a distribution table or award table after distributing an award to each player and/or until all awards have been distributed. For example, this includes updating generated first set of probabilities with the generated second set of probabilities (step 710 of method 700). Update may refer to writing, overwriting, swapping, exchanging, renewing, or any other method of replacing new data with existing data. Non-limiting examples of updating may include writing new data on top of existing data and erasing the then existing data. For example, a second set of probabilities, 0%, 0%, 0%, 0%, 0%, 3.51%, 96.49%, and 0%, may update a first set of probabilities 0.01%, 0.01%, 0.01%, 0.15%, 3.5%, 96.32%, 0%, and 0%. In some embodiments, the generated third set of probabilities may update the generated second set of probabilities, and so on.

In some embodiments, the distribution table or the award table may be sent to a server. Server may refer to a computer program or computer device that provides a service to another computer program or computer device. Non-limiting examples of server may include a game server, a central server, a local server, and a client device. For example, a distribution table or award table may be sent to the server. In another example, the server may send the distribution table or the award table to a client device.

According to another embodiment of the present disclosure, a method for dynamically generating award probabilities may be provided. Consistent with disclosed embodiments, the method includes retrieving, from a memory, predetermined awards. Each predetermined award may be associated with an award value. The method further includes retrieving, from the memory, game player data. Game player data may refer to any data or information that relates or originates from a game. The method further includes generating, via the dynamic distribution table generator, a second set of probabilities a second player, from the plurality of players, wins each predetermined award. The first set of probabilities and the second set of probabilities may be based on game player data and/or other input data. The method additionally includes storing the generated first set of probabilities in a distribution table and/or an award table. Each probability of the generated first set of probabilities may correspond to the predetermined awards. The method includes updating the generated first set of probabilities with the generated second set of probabilities.

By way of example, FIG. 8 illustrates a distribution table 802 and an award table 800. Distribution table 802 includes award values 804 (e.g., $0.50, $0.50, $0.50) and first set of probabilities 806 (e.g., 0%, 0%, 96.32%). Method 700 includes a step 702 of retrieving, from a memory, predetermined awards 808 (e.g., Award 8, Award 7, Award 6), wherein each predetermined award 808 (e.g., Award 8, Award 7, Award 6) is associated with an award value 804 (e.g., $0.50, $0.50, $0.50). Method 700 also includes a step 704 of generating a first set of probabilities 806 (e.g., 0%, 0%, 96.32%) a first player from a plurality of players wins each predetermined award 808 (e.g., Award 8, Award 7, Award 6), wherein the first set of probabilities 806 (e.g., 0%, 0%, 96.32%) is based on game player data that is received from the electronic gaming machines or stored in memory. Together, this forms example award table 800.

By way of example, FIG. 9 illustrates a distribution table 902 and award table 900. Distribution table 902 includes award values 904 (e.g., $0.50, $0.50, $0.50) and second set of probabilities 906 (e.g., 0%, 96.49%, 3.51%). Method 700 includes a step 702 of retrieving, from a memory, predetermined awards 908 (e.g., Award 8, Award 7, Award 6), wherein each predetermined award 908 (e.g., Award 8, Award 7, Award 6) is associated with an award value 904 (e.g., $0.50, $0.50, $0.50). Method 700 also includes a step 706 of generating a second set of probabilities 906 (e.g., 0%, 96.49%, 3.51%) a second player from a plurality of players wins each predetermined award 908 (e.g., Award 8, Award 7, Award 6), wherein the second set of probabilities 606 (e.g., 0%, 96.49%, 3.51%) is based on game player data that is received from the electronic gaming machines or stored in memory. Together, this forms exemplary award table 900.

By way of example, FIG. 10 illustrates a distribution table 1002 and an award table 1000. Distribution table 1002 includes award values 1004 (e.g., $0.50, $0.50, $0.50) and third set of probabilities 1006 (e.g., 50%, 50%, 0%). Together, this forms example award table 1000.

The diagrams and components in the figures described above illustrate the architecture, functionality, and operation of possible implementations of systems, methods, and computer hardware or software products according to various example embodiments of the present disclosure. For example, each block in a flowchart or diagram may represent a module, segment, or portion of code, which includes one or more executable instructions for implementing the specified logical functions. It should also be understood that in some alternative implementations, functions indicated in a block may occur out of order noted in the figures. By way of example, two blocks or steps shown in succession may be executed or implemented substantially concurrently, or two blocks or steps may sometimes be executed in reverse order, depending upon the functionality involved. Furthermore, some blocks or steps may be omitted. It should also be understood that each block or step of the diagrams, and combination of the blocks or steps, may be implemented by special purpose hardware-based systems that perform the specified functions or acts, or by combinations of special purpose hardware and computer instructions. Computer program products (e.g., software or program instructions) may also be implemented based on the described embodiments and illustrated examples.

It should be appreciated that the above-described systems and methods may be varied in many ways and that different features may be combined in different ways. In particular, not all the features shown above in a particular embodiment or implementation are necessary in every embodiment or implementation. Further combinations of the above features and implementations are also considered to be within the scope of the herein disclosed embodiments or implementations.

While certain embodiments and features of implementations have been described and illustrated herein, modifications, substitutions, changes and equivalents will be apparent to those skilled in the art. It is, therefore, to be understood that the appended claims are intended to cover all such modifications and changes that fall within the scope of the disclosed embodiments and features of the illustrated implementations. It should also be understood that the herein described embodiments have been presented by way of example only, not limitation, and various changes in form and details may be made. Any portion of the systems and/or methods described herein may be implemented in any combination, except mutually exclusive combinations. By way of example, the implementations described herein can include various combinations and/or sub-combinations of the functions, components and/or features of the different embodiments described.

Moreover, while illustrative embodiments have been described herein, the scope of the present disclosure includes embodiments having equivalent elements, modifications, omissions, combinations (e.g., of aspects across various embodiments), adaptations or alterations based on the embodiments disclosed herein. Further, elements in the claims are to be interpreted broadly based on the language employed in the claims and not limited to examples described herein or during the prosecution of the present application. Instead, these examples are to be construed as non-exclusive. It is intended, therefore, that the specification and examples herein be considered as exemplary only, with a true scope and spirit being indicated by the following claims and their full scope of equivalents.

What is claimed is:

1. A computer-implemented method for dynamically controlling the distribution of awards for an electronic game, the method comprising the following operations performed by at least one processor:
receiving game player data for the electronic game;
determining a distribution table input based on the game player data, the distribution table input including at least one of a number of players participating in the electronic game and a total wager by the players participating in the electronic game;
generating a distribution table based on the determined distribution table input, the distribution table including a plurality of award values related to a plurality of predetermined awards and a plurality of probabilities associated with the plurality of predetermined awards;
generating an award table based on the generated distribution table, the award table including a plurality of award identifiers; and
distributing awards to the players based on the award table.

2. The computer-implemented method according to claim 1, wherein each award identifier is associated with an award value among the plurality of award values and a corresponding probability among the plurality of probabilities.

3. The computer-implemented method according to claim 1, wherein the method further comprises determining, from the game player data, at least one of a place, score, or position of the players participating in the electronic game.

4. The computer-implemented method according to claim 3, wherein the method further comprises determining player identifiers corresponding to the award identifiers, wherein there is at least one player identifier that is determined for at least one of the plurality of award identifiers.

5. The computer-implemented method according to claim 4, wherein distributing awards to players comprises distributing an award to a player associated with the at least one player identifier that is determined for the at least one of the plurality of award identifiers.

6. The computer-implemented method according to claim 1, wherein the method further comprises receiving the game player data from data feeds from electronic gaming machines used by the players participating in the electronic game.

7. The computer-implemented method according to claim 1, wherein the award table comprises the distribution table and the method comprises modifying the award table by updating the plurality of probabilities with another plurality of probabilities.

8. The computer-implemented method according to claim 1, wherein the plurality of probabilities is a first set of probabilities and the another plurality of probabilities is a second set of probabilities, and wherein the method further comprises:
generating the first set of probabilities a first player wins each predetermined award, wherein the first set of probabilities is based on the game player data;
generating the second set of probabilities a second player wins each predetermined award, wherein the second set of probabilities is based on the game player data;
storing the generated first set of probabilities in the distribution table; and
updating the generated first set of probabilities with the generated second set of probabilities.

9. A non-transitory computer readable medium containing instructions that when executed by at least one processor cause the at least one processor to perform operations for dynamically controlling the distribution of awards for an electronic game, the operations comprising:
receiving game player data for the electronic game;
determining a distribution table input based on the game player data, the distribution table input including at least one of a number of players participating in the electronic game and a total wager by the players participating in the electronic game;
generating a distribution table based on the determined distribution table input, the distribution table including a plurality of award values related to a plurality of predetermined awards and a plurality of probabilities associated with the plurality of predetermined awards;
generating an award table based on the generated distribution table, the award table including a plurality of award identifiers; and
distributing awards to the players based on the award table.

10. The non-transitory computer readable medium according to claim 9, wherein each award identifier is associated with an award value among the plurality of award values and a corresponding probability among the plurality of probabilities.

11. The non-transitory computer readable medium according to claim 9, wherein the operations performed by the at least one processor further comprises determining, from the game player data, at least one of a place, score, or position of the players participating in the electronic game.

12. The non-transitory computer readable medium according to claim 11, wherein the operations performed by the at least one processor further comprises determining player identifiers corresponding to the award identifiers, wherein there is at least one player identifier that is determined for at least one of the plurality of award identifiers.

13. The non-transitory computer readable medium according to claim 12, wherein distributing awards to players comprises distributing an award to a player associated with the at least one player identifier that is determined for the at least one of the plurality of award identifiers.

14. The non-transitory computer readable medium according to claim 9, wherein the operations performed by the at least one processor further comprises receiving the game player data from data feeds from electronic gaming machines used by the players participating in the electronic game.

15. The non-transitory computer readable medium according to claim 9, wherein the award table comprises the distribution table and the method comprises modifying the award table by updating the plurality of probabilities with another plurality of probabilities.

16. The non-transitory computer readable medium according to claim 9, wherein the plurality of probabilities is a first set of probabilities and the another plurality of probabilities is a second set of probabilities, and wherein the operations performed by the least one processor further comprises:
generating the first set of probabilities a first player wins each predetermined award, wherein the first set of probabilities is based on the game player data;
generating the second set of probabilities a second player wins each predetermined award, wherein the second set of probabilities is based on the game player data;
storing the generated first set of probabilities in the distribution table; and
updating the generated first set of probabilities with the generated second set of probabilities.

17. A computer-implemented method for dynamically controlling the distribution of awards, the method comprising the following operations performed by at least one processor:
retrieving stored data associated with an award table including a plurality of award identifiers, the award table being generated based on distribution table input related to an electronic game;
determining player identifiers corresponding to the award identifiers, wherein at least one player identifier is determined for at least one of the plurality of award identifiers;
distributing awards for the electronic game, identified by the plurality of award identifiers, to players corresponding to the determined player identifiers; and
storing data, in a memory, to record the distribution of awards to the players.

18. The computer-implemented method of claim 17, wherein the electronic game is a first electronic game, the award table is a first award table, and the distribution table input is a first distribution table input, and wherein the method further includes:
retrieving stored data associated with a second award table including a plurality of second award identifiers, the second award table being generated based on a second distribution table input related to a second electronic game;
determining second player identifiers corresponding to the second award identifiers, wherein at least one player identifier is determined for at least one of the plurality of second award identifiers; and
distributing awards for the second electronic game, identified by the plurality of second award identifiers, to players corresponding to the determined second player identifiers.

19. The computer-implemented method of claim 17, wherein the method further comprises:
retrieving stored data associated with game player data, wherein the game player data includes a first-place player, a second-place player, and a third-place player; and
matching the first-place player with a first player identifier, the second-place player with a second player identifier, and the third-place player with a third player identifier.

20. The computer-implemented method of claim 17, wherein the method further comprises:
retrieving stored data associated with game player data, wherein the game player data includes a first-position player, a second-position player, and a third-position player; and
matching the first-position player with the first player identifier, the second-position player with the second player identifier, and the third-position player with the third player identifier.

21. The computer-implemented method of claim 17, wherein the method further comprises:
retrieving stored data associated with game player data, wherein the game player data includes a first-score player, a second-score player, and a third-score player; and
matching the first-score player with the first player identifier, the second-score player with the second player identifier, and the third-score player with the third player identifier.

22. The computer-implemented method of claim 17, wherein distributing awards includes distributing participation awards.

23. The computer-implemented method of claim 17, wherein the award table is generated based on a distribution table, the distribution table is based on the distribution table input, and the distribution table input includes a number of active players associated with a plurality of gaming machines that participate in the electronic game.

24. The computer-implemented method of claim 17, wherein the award table is generated based on a distribution table, the distribution table is based on the distribution table input, and the distribution table input includes a total wager for the electronic game.

25. A computer-implemented system for dynamically controlling the distribution of awards for an electronic game, the system comprising:
a plurality of electronic gaming machines associated with a plurality of players validated to participate in the electronic game, each of the plurality of electronic gaming machines configured to provide a data feed for the electronic game;
a dynamic distribution table generator configured to generate a distribution table for the electronic game based on the data feed from each of the plurality of electronic gaming machines;
at least one processor programmed to:
retrieve stored data associated with an award table including a plurality of award identifiers, the award table being generated based on the distribution table for the electronic game;
determine player identifiers corresponding to the award identifiers, wherein at least one player identifier is determined for each of the plurality of award identifiers;
distribute awards for the electronic game, identified by the plurality of award identifiers, to players corresponding to the determined player identifiers; and
store data, in a memory, to record the distribution of awards to the players.

26. A non-transitory computer readable medium containing instructions that when executed by at least one processor cause the at least one processor to perform operations for dynamically generating award probabilities, the operations comprising:
retrieving, from a memory, predetermined awards, wherein each predetermined award is associated with an award value;
retrieving, from the memory, game player data;
generating, with a dynamic distribution table generator, a first set of probabilities a first player from a plurality of players wins each predetermined award, wherein the first set of probabilities is based on the game player data;
generating, with the dynamic distribution table generator, a second set of probabilities a second player from the plurality of players wins each predetermined award, wherein the second set of probabilities is based on the game player data;
storing the generated first set of probabilities in a distribution table, wherein each probability of the generated first set of probabilities corresponds to the predetermined awards; and
updating the generated first set of probabilities with the generated second set of probabilities.

27. The non-transitory computer readable medium of claim 26, wherein the operations further include:
generating, with the dynamic distribution table generator, a third set of probabilities a third player from the plurality of players wins each predetermined award, wherein the third set of probabilities is based on the game player data; and
updating the generated second set of probabilities with the generated third set of probabilities.

28. The non-transitory computer readable medium of claim 26, wherein the operations further include sending the distribution table to a server.

29. A computer-implemented method for dynamically generating award probabilities, the method comprising:
retrieving, from a memory, predetermined awards, wherein each predetermined award is associated with an award value;
retrieving, from the memory, game player data;
generating, with a dynamic distribution table generator, a first set of probabilities a first player from a plurality of players wins each predetermined award, wherein the first set of probabilities is based on the game player data;
generating, with the dynamic distribution table generator, a second set of probabilities a second player from the plurality of players wins each predetermined award, wherein the second set of probabilities is based on the game player data;
storing the generated first set of probabilities in a distribution table, wherein each probability of the generated first set of probabilities corresponds to the predetermined awards; and
updating the generated first set of probabilities with the generated second set of probabilities.

30. A computer-implemented system comprising:
a plurality of electronic gaming machines associated with a plurality of players;
a controller configured to:
validate one or more of the plurality of players to participate in an electronic game on respective ones of the plurality of gaming machines; and
enable validated players on respective ones of the plurality of gaming machines to participate in game play for the electronic game; and
a data analyzer configured to:
receive, from the plurality of gaming machines, game player data;
determine, from the received game player data, at least one of a place, score, or position of the validated players;
store, in a memory, data associated with determinations of the at least one of the place, score, or position of the validated plurality of players;
retrieve, from the memory, a distribution table including data identifying a distribution of a plurality of awards;
award, based on the distribution table, the distribution of each of the plurality of awards;
collect data associated with the awards distributions including whether each award distribution was successful or unsuccessful; and
store, in the memory, data associated with the awards distribution.

31. The computer-implemented system of claim 30 wherein the data analyzer is further configured to send data associated with the awards distribution to a server.

32. The computer-implemented system of claim 30, wherein:
the controller is further configured to determine whether a change occurs to the plurality of gaming machines associated with the plurality of players;
if a change occurs:
the controller is further configured to re-validate one or more of the plurality of players to participate in game play on respective ones of the plurality of gaming machines;
the controller is further configured to re-enable game play by the validated players on the respective ones of the plurality of gaming machines;
the data analyzer is further configured to:
receive, from the memory, changed game player data from the plurality of gaming machines and determine whether at least one of the place, score, or position of the validated plurality of players changed; and
store, in the memory, changed game player data from the plurality of gaming machines and data associated with determinations of the changed at least one of the place, score, or position of the validated plurality of players.
